(19) United States
(12) Patent Application Publication
(10) Pub. No.: US 2026/0098523 A1
(43) Pub. Date: Apr. 9, 2026

(54) NON-LINEAR FLUX-BALANCED MAGNETIC CIRCUIT FOR THRUSTER

(71) Applicant: CALIFORNIA INSTITUTE OF TECHNOLOGY, PASADENA, CA (US)

(72) Inventor: Jacob B. SIMMONDS, PASADENA, CA (US)

(21) Appl. No.: 18/903,911

(22) Filed: Oct. 1, 2024

Related U.S. Application Data
(60) Provisional application No. 63/545,422, filed on Oct. 24, 2023.

(51) Int. Cl. F03H 1/00; B64G 1/40; H01F 7/20; H01F 27/24

(52) U.S. Cl. CPC F03H 1/0037; B64G 1/413; H01F 7/202; H01F 27/24

(57) ABSTRACT

A flux-balanced magnetic circuit for an electric propulsion (EP) system is presented. The magnetic circuit includes a magnetic core with a thickness profile that is configured to equalize the magnetic flux conducted through a magnetically permeable material of magnetic elements of the magnetic core, including an inner pole, an outer pole, an inner screen, and outer screen, and a baseplate. According to one aspect, equalization of the magnetic flux is provided for operation of the magnetic circuit in a linear regime and a nonlinear regime. According to another aspect, the thickness profile includes a region with varying thickness. According to another aspect, the thickness profile in the region with varying thickness is configured to follow shape and/or contour of magnetic flux lines of the magnetic flux. According to another aspect, the curvature and/or slope is configured to increase a material thickness in a region of higher magnetic flux density.

### CROSS REFERENCE TO RELATED APPLICATIONS

The present application claims priority to and the benefit of U.S. provisional patent application Ser. No. 63/545,422 entitled “Non-Linear, Flux-Balanced Hall Thruster Magnetic Circuit”, filed on Oct. 24, 2023, the disclosure of which is incorporated herein by reference in its entirety.

### STATEMENT OF GOVERNMENT GRANT

This invention was made with government support under Grant No. 80NMO0018D0004 awarded by NASA (JPL). The government has certain rights in the invention.

### TECHNICAL FIELD

The present disclosure relates to electric propulsion systems. More particularly, it relates to design and operation of a reduced mass and size magnetic circuit for electric propulsion systems.

### BACKGROUND

Electric propulsion (EP) systems (e.g., Hall thrusters, gridded ion thrusters) use applied electric and magnetic fields to accelerate ions to extremely high velocities to generate thrust for a spacecraft. They are one of the most efficient forms of thrust available to modern spacecraft and are now regularly flown on commercial, military, and civil space missions. EP systems offer several benefits for the deep-space missions typically flown in the civil space sector, including not only higher delivered mass, but lesser appreciated capabilities such as launch window flexibility, the elimination of critical events like orbit insertion, and shorter flight times for certain missions that would otherwise require multiple planetary fly-bys.

Methods to achieve efficient, high specific impulse (e.g., greater than 3000 s) operation in EP systems, such as Hall thrusters, including application of higher magnetic field strengths, have been demonstrated. Combined with magnetic shielding, high specific impulse Hall thrusters are now possible with propellant throughput capabilities (i.e., long life) that are necessary for high velocity change (e.g., delta-V greater than 10 km/s) missions across the solar system. A conducting wall, magnetically shielded Hall thruster, which includes an annular discharge chamber with an inner wall made of a conductive material, such as a metal, is described in, e.g., U.S. Pat. No. 9,453,502, the description of which is incorporated herein by reference in its entirety.

In order to generate the desired shape (e.g., symmetry) and strength of the magnetic field in a discharge channel (chamber) of an EP system, such as a Hall thruster, a magnetic circuit (e.g., an electromagnetic circuit) that includes high magnetic permeability material is utilized. The highest magnetic field strength in the discharge channel of the EP system is determined by how much magnetic flux can be directed through the magnetic circuit and through air gaps inherent to the structure/design of the EP system (e.g., air gap of the discharge channel and air gaps between elements of the magnetic circuit).

Magnetically permeable materials display (magnetic) saturation of magnetic flux as the magnetic flux increases typically on the order of 10 to 20 kG (kilo-Gauss). Such increase of magnetic flux may be provided via an increase of current density in coils of electromagnets, or via stronger permanent magnets, of the magnetic circuit. As the magnetic flux increases and the magnetically permeable material of the magnetic circuit approaches saturation, the magnetic flux generated by the magnetic circuit begins to leak out of the magnetic circuit (e.g., diverting from its intended/designed path), thereby removing the typical linear behavior of the magnetic circuit. Such leakage of the magnetic flux, based on loss of magnetic flux through the magnetically permeable material of the magnetic circuit (i.e., of magnetic core), leads to warping (e.g., distorting) of the magnetic field (lines) in the discharge channel, which in turn leads to loss of performance/efficiency of the EP system as well as potential high erosion due to loss of magnetic shielding.

To guarantee the linear behavior of the magnetic circuit, and therefore avoid approaching saturation of the magnetic flux throughout an operating range of the magnetic circuit, size and therefore mass of elements that make the magnetic circuit may be increased. However, such increase in size and mass may come at the cost of higher overall EP system mass and size.

In view of the above, teachings according to the present disclosure address challenges in generation of higher magnetic field strengths in electric propulsion systems, such as Hall thrusters, while maintaining a reduced size and mass of the magnetic circuit.

### SUMMARY

According to a first aspect of the present disclosure, a flux-balanced magnetic circuit for an electric propulsion (EP) system is presented, comprising: a magnetic core with a thickness profile that is configured to equalize a magnetic flux conducted through a magnetically permeable material of magnetic elements of the magnetic core during operation of the flux-balanced magnetic circuit in a linear regime and a nonlinear regime.

According to a second aspect of the present disclosure, a reduced mass high-power Hall thruster is presented, comprising: a discharge chamber with a longitudinal extension according to an axial direction of the Hall thruster; and a magnetic circuit for generation in the discharge chamber of magnetic field lines according to a radial direction, the magnetic circuit comprising a magnetic core and a magnet system; wherein, the magnetic core includes a thickness profile that is configured to equalize a magnetic flux conducted through a magnetically permeable material of the magnetic core during operation of the magnetic circuit in a linear regime and a nonlinear regime, thereby maintaining a substantially constant shape of the magnetic field lines during operation in the linear regime and the nonlinear regime, and the thickness profile includes a region with varying thickness, wherein the thickness profile in the region with the varying thickness is configured to follow a contour of magnetic flux lines of the magnetic flux, thereby reducing mass of the magnetic core by removing portions of the magnetically permeable material devoid of magnetic flux.

According to a third aspect of the present disclosure, a method for reducing mass and size of a magnetic circuit of an electric propulsion (EP) system is presented, the method comprising: providing dimensions of a discharge channel of the EP system; providing desired shape of a magnetic field produced in the discharge channel by a magnetic circuit of the EP system; based on the providing and the providing, iteratively tuning a thickness profile of a magnetic core of the magnetic circuit while validating provision of the desired shape of the magnetic field via finite element model (FEM) simulation of a correspondingly produced magnetic field; repeating the iteratively tuning of the thickness profile for different strengths of the produced magnetic field, the different strengths spanning across a linear regime and a nonlinear regime of the magnetic circuit; and based on the repeating, deriving an optimal thickness profile of a flux-balanced magnetic core that is configured to equalize a magnetic flux conducted through a magnetically permeable material of the magnetic core during operation of the magnetic circuit in a linear regime and a nonlinear regime.

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1A shows a picture of a prior art electric propulsion (EP) system.

FIG. 1B shows a simplified cross-sectional schematic of a magnetic core of a conventional prior art magnetic circuit.

FIG. 2A shows a simplified representation of magnetic field lines produced by the magnetic circuit of FIG. 1B during operation in a linear regime.

FIG. 2B shows a simplified representation of magnetic field lines produced by the magnetic circuit of FIG. 1B during operation in a nonlinear regime.

FIG. 3A shows a simplified cross-sectional schematic of a magnetic core of a magnetic circuit according to an embodiment of the present disclosure.

FIG. 3B shows contrast in thickness profiles of the conventional prior magnetic core and the magnetic core according to the present disclosure.

FIG. 4A shows a simplified representation of magnetic field lines produced by the magnetic circuit of FIG. 3A during operation in a linear regime.

FIG. 4B shows a simplified representation of magnetic field lines produced by the magnetic circuit of FIG. 3A during operation in a nonlinear regime.

Like reference numbers and designations in the various drawings indicate like elements.

### DETAILED DESCRIPTION

A magnetic circuit according to the present disclosure includes all structures intended for generation of a magnetic field shape/profile and strength of an EP system, such as, for example, a Hall (effect) thruster. Accordingly, the magnetic circuit may include one or more permanent magnets or electromagnets configured to magnetically energize a magnetic core made of a high magnetic permeability material (e.g., ferromagnetic material).

Teachings according to the present disclosure may equally apply to magnetically shielded EP systems with walls (102d, 102p) of the discharge channel (102, discharge chamber) entirely made of a conductive material (e.g., metal). In magnetically shielded EP systems, and independently of material choice for the walls (e.g., walls 102d, 102p made of conductive or insulating material), inner edges of the walls (102d, 102p) may include slopes to further participate in the shielding of the walls (102d, 102p) from the erosive effects of the plasma, as described, for example, in the above referenced U.S. Pat. No. 9,453,502.

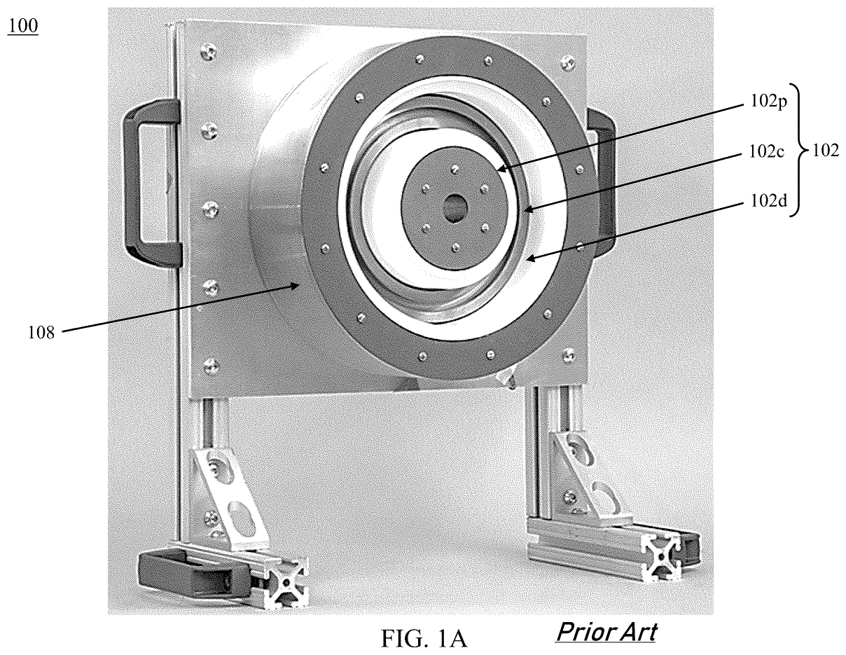

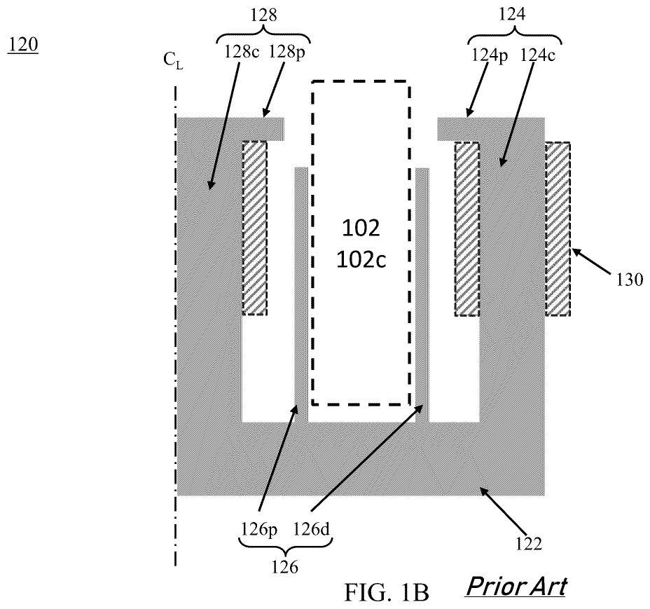

FIG. 1A shows a picture of an EP system (100) that may include a conventional (prior art) magnetic circuit or a magnetic circuit according to the present disclosure. As shown in FIG. 1A, the EP system (100) may include an axial symmetry about a center axis (e.g., C_{L} of FIG. 1B) about which (annular) elements/structures of the EP system (100) may be arranged. These include, for example, a (plasma) discharge channel (102 e.g., discharge chamber) laterally bounded by outer wall (102d, distal to the center axis, C_{L}) and inner wall (102p, proximal to the center axis, C_{L}) that may be made from insulating and/or conductive material. Within the inner space (102c, channel, air gap) of the discharge channel (102), propellant ions may be accelerated outwardly (from upstream region towards downstream region of the discharge channel) via electric fields (e.g., Hall effect or electric grid electrodes) produced in the EP system (100). Operation of the EP system (100) may be further based on magnetic field lines produced within the inner space (102c) of the discharge channel (102) by a corresponding magnetic circuit.

FIG. 1B shows a simplified cross-sectional schematic of a magnetic core (120) of a conventional magnetic circuit (120, 130) that may be used in the EP system (100) of FIG. 1A. As shown in FIG. 1B, symmetrically arranged (about the center axis, C_{L}, only one half of the cross sectional is shown) are elements/structures (122, 124, 126, 128) that form the magnetic core (120). The magnetic core (120) may be made of a magnetically permeable material (e.g., ferromagnetic material, soft magnetic material) that is magnetically energized via a magnet system (130, e.g., based on permanent magnets or electromagnets). Within the inner space (102c) of the discharge channel (102), the magnetic circuit (120, 130) may generate a radial magnetic field that is perpendicular to an electric field produced in (or about, e.g., via a combination of an anode and a cathode of the EP system) the discharge channel (102). It is noted that design/arrangement of the magnet system (130) for energization of the magnetic core (120) via an applied magnetic field generated by the magnet system (130) is known in the art and not the subject of the present application.

The magnetic core (120) shown in FIG. 1B may include a baseplate (122) upon which elements (124, 126, 128) of the magnetic core (120) may be fastened (e.g., bolted, fixated, mounted, connected, etc.). In some embodiments, two or more of the elements (122, 124, 126, 128) may be monolithically integrated into one single monolithic structure. Such integration may be provided via, for example, known in the art subtractive and/or additive manufacturing methods and practices. A monolithic structure according to the present disclosure may not include any fasteners/bolts or welding/glue to form a three-dimensional shape of the structure.

Elements of the magnetic core (120) include an outer core structure (124, also referred to as outer pole) that includes a laterally arranged axial extension (124c) and a top radial extension (124p) that inwardly extends towards the center axis, C_{L}; an inner core structure (128, also referred to as inner pole) that includes a centrally arranged axial extension (128c) and a top/downstream radial extension (128p) that outwardly extends away from the center axis, C_{L}. Further included in the magnetic core (120) is a screen structure (126) that includes an inner screen (126p, arranged proximal the center axis, C_{L}) arranged between the discharge channel (102) and the inner core structure (128), and an outer screen (126d, arranged distal the center axis, C_{L}) arranged between the discharge channel (102) and the outer core structure (124). The magnetic circuit (120, 130) or the magnetic core (120) may be described as comprising an inner magnetic (sub-)circuit/core that may include elements (128, 126p) arranged over an inner region/surface of the baseplate (122) that is proximal the center axis, C_{L}, and an outer magnetic (sub-)circuit/core that may include elements (124, 126d) arranged over an outer region/surface of the baseplate (122) that is distal the center axis, C_{L}.

With continued reference to FIG. 1B, because the elements (122, 124, 126, 128) of the magnetic core (120) are made of a magnetically permeable material, such elements may be considered as slipstreams for magnetic flux. When a magnet (e.g., of the magnetic circuit 120, 130, such as a permanent magnet or an electromagnet 130) is placed in the air/vacuum next to a magnetically permeable material (e.g., of the magnetic core 120), the magnetic field generated by the magnet will bend into the permeable material as it has a lower (magnetic) resistivity (e.g., reluctance) to the magnetic field compared to the air/vacuum. By proper placement/arrangement of magnetically permeable material (i.e., as provided via elements 122, 124, 126, 128) about an air gap presented by the discharge channel (102) of the EP system (100), a magnetic circuit (120, 130) that forces the magnetic field to go through such air gap can be designed (e.g., closed, magnetically closed).

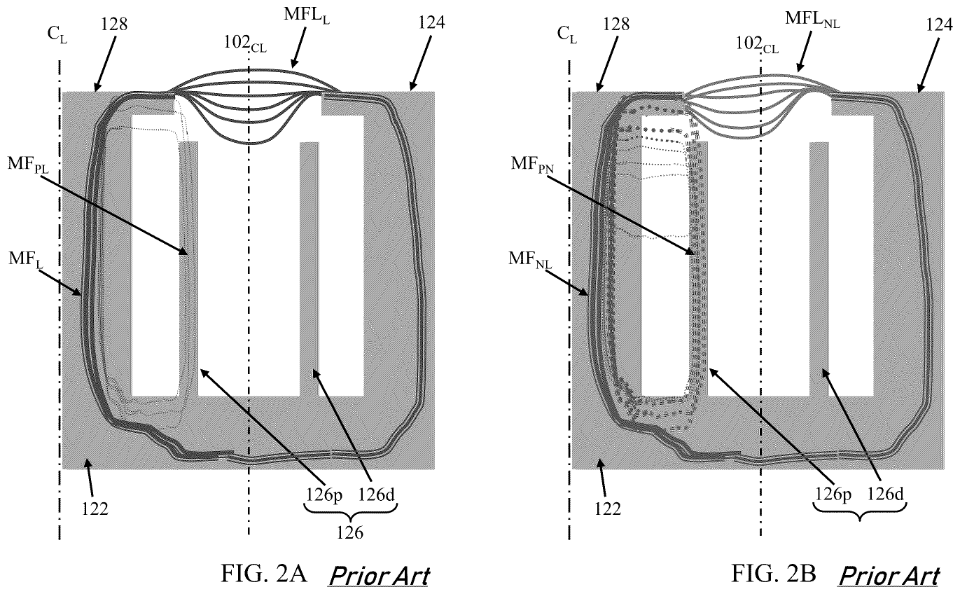

In other words, and as shown in FIG. 2A, in order to (magnetically) “close” the magnetic circuit, the magnetic field, or in other words, the magnetic field lines, MFL_{L}, of the magnetic field must traverse a portion of the air gap presented by the discharge channel (102, 102c of FIG. 1B). As shown in FIG. 2A, such portion of the air gap is provided by the opening/distance separating the inner pole (128, e.g., 128p of FIG. 1A) from the outer pole (124. e.g., 124p of FIG. 1A) within which the discharge channel (102, shown in FIG. 1B) is arranged. The proper placement/arrangement of the magnetically permeable material, including shape of various elements (122, 124, 126, 128) of the magnetic core (120, e.g., inner/outer core, inner/outer screen, baseplate, etc.) of the magnetic circuit (e.g., 120, 130), can therefore provide a desired magnetic field profile/shape in the air gap of the discharge channel (102). As shown in the FIG. 2A, such desired magnetic field profile/shape includes a symmetry about a centerline, 102_{CL}, of the discharge channel (102, shown in FIG. 1B) that passes through a center of the air gap separating the two poles (124) and (128). Is should be noted that due to the structural symmetry of the EP system about the center axis, C_{L}, the desired symmetry of the magnetic field profile/shape may be with respect to the center axis, C_{L}, and with respect to the locus of the centerline, 102_{CL}, that is provided by a cylinder centered at the center axis, C_{L}.

According to the present disclosure, a linear regime of the magnetic circuit/core (e.g., 120, 130) may be considered as a region of operation of the magnetic circuit/core (e.g., 120, 130) wherein the magnetic flux density through the magnetically permeable material of the magnetic core (120, i.e., elements 122, 124, 126, 128, e.g., magnetic circuit) increases linearly as a function of the applied magnetic field strength (as provided by the magnet 130). Accordingly, when operating in the linear regime, the overall shape/profile, of the magnetic field (e.g., MFL_{L} of FIG. 2A) in (the air gap of) the discharge channel, including symmetry with respect to the centerline, 102_{CL}, remains (essentially) unchanged for an increase in the applied magnetic field strength.

Saturation, or magnetic saturation, according to the present disclosure, can be considered as a state reached when an increase in applied magnetic field (e.g., via permanent magnet or electromagnet) to (the magnetically permeable material of) the magnetic core (120) cannot increase magnetic flux density in the magnetic core (120). In other words, magnetic saturation may be described as a state reached when the magnetic flux density in the magnetic core has plateaued, or reached a maximum (saturation) level. It follows that during operation in the linear regime, elements (e.g., 122, 124, 126, 128) of the magnetic core (120) must operate away from saturation (e.g., permeability of the permeable material remains substantially constant).

It should be noted that during operation in the linear regime, the magnetic flux, designated as MF_{L} in FIG. 2A, conducted through the magnetically permeable material of the magnetic core (120, i.e., elements 122, 124, 126, 128) may escape a desired conduction path leading to the magnetic field lines, MFL_{L}, and “leak” through (one or more of the) air gaps that exist between the elements (122, 124, 126, 128) of the magnetic core (120). In the simplified rendition of the magnetic flux, MF_{L}, of FIG. 2A, some leaked magnetic flux (lines) are designated (with light/faint dotted lines) as MF_{PL}. For example, the (exemplary) leaked magnetic flux, MF_{PL}, shown in FIG. 2A escapes the inner core (128) and traverses an air gap between the inner core (128) and the inner screen (126p) to generate leaked magnetic field lines between the inner core (128) and the inner screen (126p). Depending on the geometry of the magnetic core (120), including air gap created between the elements (122, 124, 126, 128), one or more such magnetic leakages may exist.

Although such magnetic leakage(s) may exist in the linear regime, it may be considered as a secondary/tertiary effect (therefore MF_{PL} rendered with light/faint lines in FIG. 2A) with negligible influence in the mode of operation governing the linear regime. In other words, the leaked magnetic flux (e.g., MF_{PL} of FIG. 2A) may be attributed to a parasitic magnetic circuit characterized by a magnetic resistance that is substantially higher than the magnetic resistance of the primary magnetic circuit that is intentionally designed to generate the magnetic field lines MFL_{L}. However, and as further discussed below in the present disclosure, for higher strength applied magnetic fields, the magnetic resistance of the primary magnetic circuit (i.e., as provided by the permeability of the magnetic material for higher magnetic flux) may increase relative to the parasitic magnetic circuit, thereby promoting substantially more leaked magnetic flux through the parasitic magnetic circuit. In other words, the primary magnetic circuit and the parasitic magnetic circuit may combine to provide a mode of operation that cannot be considered linear, but rather nonlinear.

As the applied magnetic field strength further increases (e.g., via stronger permanent magnet or higher current density of an electromagnet), the elements (e.g., 122, 124, 126, 128) of the magnetic core (120) gradually approach saturation. In other words, the further increasing of the applied magnetic field causes the magnetic flux density through the magnetically permeable material of the magnetic circuit/core to (asymptotically) approach the maximum saturation level. In other words, the further increasing of the applied magnetic field causes the magnetic flux density through the magnetically permeable material of the magnetic circuit to (asymptotically) increase in a nonlinear manner and with a reduced rate compared to a rate provided in the linear regime.

According to the present disclosure, a nonlinear regime of the magnetic circuit/core (e.g., 120, 130) may be considered as a region of operation of the magnetic circuit/core (e.g., 120, 130) wherein the magnetic flux density through the magnetically permeable material of the magnetic core (120, i.e., elements 122, 124, 126, 128, e.g., magnetic circuit) approaches saturation and therefore increases nonlinearly (and with a reduced rate) as a function of the applied magnetic field strength (as provided by the magnet 130 of FIG. 1B). As previously described in the present disclosure, operation according to the nonlinear regime may be concurrent with an increase of magnetic leakage through the parasitic magnetic circuit whose effect on operation of the primary magnetic circuit is no longer negligeable.

FIG. 2B shows the (conventional) magnetic circuit (120, including elements 122,124,126, 128) of FIG. 2A operating in the nonlinear regime. When operating in the nonlinear regime, permeability of the magnetic material of the magnetic core (120), including of elements (122, 124, 126, 128), drops as a function of increasing applied magnetic field. In other words, the material's magnetic resistance increases and as a consequence, a higher portion (e.g., MF_{PN}) of the applied magnetic field, or in other words, of the magnetic flux, MF_{NL}, through the elements (122,12,4, 126, 128) may escape the (primary) magnetic circuit/core (e.g., 120, 130) through paths with lower magnetic resistance, or in other words, leak into the parasitic circuit.

Accordingly, and as shown in FIG. 2B, during operation in the nonlinear regime, a substantially larger portion (designated as MF_{PN}) of the magnetic flux, MF_{NL}, leaks out of the magnetic circuit/core (e.g., 120, 130) through the paths provided by such air gaps, thereby causing, in conventional EP systems, such as known in the art Hall thrusters, an undesired change (e.g., warping, distortion) in the shape/profile of the magnetic field formed in the air gap of the discharge channel. To be more precise, the warping/distortion of the shape/profile of the magnetic field (e.g., magnetic field lines, MFL_{NL}, shown in FIG. 2B) may not be solely caused by the magnetic leakage, MF_{PN}, shown in FIG. 2B, rather by an imbalance in magnetic leakages through different elements (e.g., air gaps) of the magnetic core (120). Such imbalance of the magnetic leakages may in turn cause imbalance in the magnetic flux density in various regions/elements of the magnetic core (120), ultimately resulting in the warping/distortion of the magnetic field (e.g., magnetic field lines, MFL_{NL}, shown in FIG. 2B). In a simplistic aspect, assuming that the only magnetic leakage present in the magnetic core (120) is the magnetic leakage, MF_{PN}, shown in FIG. 2B, then it would be clear that because the magnetic flux, MF_{NL}, is maintained through the outer pole (124) and leaked though the inner pole (128), then as shown in FIG. 2B, the resultant imbalance in magnetic flux through the two elements (124, 128) results in warping/distortion of the shape/profile of the magnetic field (e.g., magnetic field lines, MFL_{NL}, shown in FIG. 2B). As described later in the present disclosure, teachings according to the present disclosure attempt to balance the (inevitable) magnetic leakages throughout the elements (122, 124, 126, 128) of the magnetic core (120) so to maintain integrity in shape/profile of the magnetic field lines.

Warping/distortion of the shape/profile of the magnetic field during operation in the nonlinear regime is represented by the magnetic field lines, MFL_{NL}, shown in FIG. 2B. As shown in FIG. 2B, the magnetic field lines, MFL_{NL}, substantially lack symmetry about the centerline, 102_{CL}. As noted above in the present disclosure, such lack of symmetry is undesirable as it can severely impact performance of the thruster. Furthermore, as shown in FIG. 2B, the (exemplary) leaked magnetic flux, MF_{PN}, during operation in the nonlinear regime is substantially more (e.g., rendered with dark/pronounced lines) compared to the leaked magnetic flux (MF_{PL} of FIG. 2A) during operation in the linear regime.

As used herein, magnetic leakage of a magnetic circuit may refer to loss of magnetic flux from the magnetic circuit/core (e.g., 120, 130) due to a portion of the total magnetic flux flowing a path that renders it ineffective for the desired function of the magnetic circuit/core. In turn, the magnetic leakage of a magnetic circuit/core may be based on a combination of magnetic leakages associated to various elements (e.g., 122, 124, 126, 128) of the magnetic circuit/core (e.g., 120, 130). In the context of an EP system, such as a Hall thruster, such magnetic leakages may be associated to elements that make the magnetic core (120) of the magnetic circuit (120, 130), including, for example, the inner core (128), the outer core (124), the inner screen (126p), the outer screen (126d), the baseplate (122), etc., and their relative separations (e.g., air/vacuum gaps). It can be said that magnetic leakages may be associated to parasitic magnetic circuits that are magnetically closed via air/vacuum gaps other than the air/vacuum gap associated with the discharge channel (102).

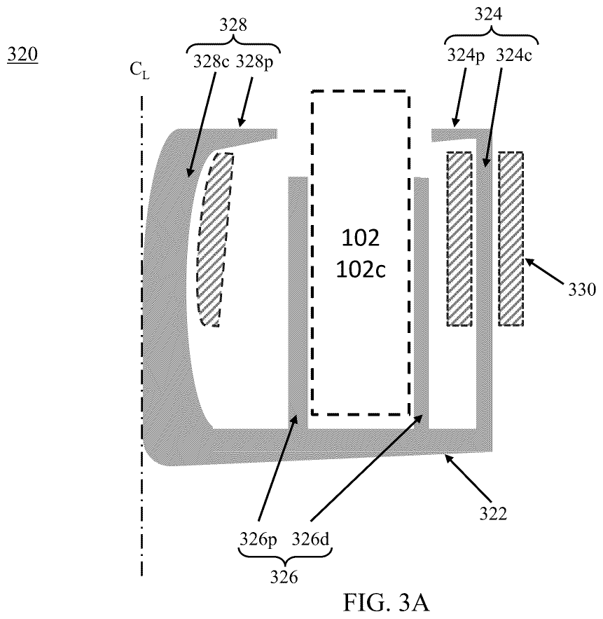

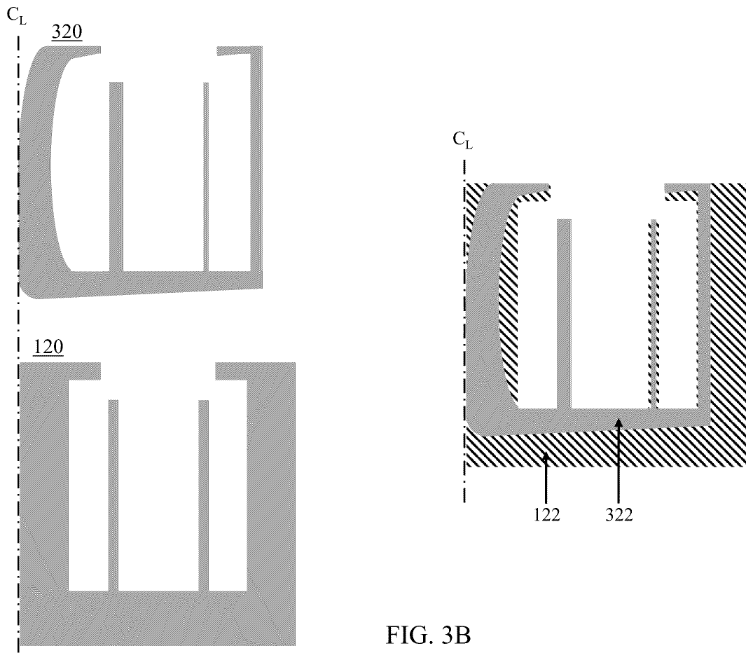

In order to overcome warping of the magnetic field profile due to (substantial and imbalanced/unequal) magnetic leakage, (conventional) magnetic circuits of conventional EP systems are designed to operate within the linear regime. In other words, in such EP systems, size and mass of the respective elements (e.g., 122, 124, 126, 128) of the magnetic core (120) is designed for operation far away from saturation and well within the linear regime where the total magnetic flux (and magnetic flux density) varies linearly with the applied magnetic field and magnetic leakage can be considered as negligible. Because a high limit of the total magnetic flux through a (magnetically permeable) material (e.g., of an element 122, 124, 126, 128) is proportional to (scales by) a cross-sectional area of the material, then increasing the cross-sectional area of the material, including via a thickness increase of the material, will increase the high limit of the total magnetic flux. Such increase in the cross-sectional area of the material in turn causes an increase in size and mass of the magnetic circuits/cores. In other words, magnetic circuits/cores (e.g., 120, 130) used in conventional EP systems are designed to include excess size and mass in order to ensure operation in the linear regime. Present inventor has estimated such excess size/mass to represent about 50% of the size/mass of the magnetic circuits/cores used in conventional EP systems (e.g., refer to FIG. 3B later described).

Such design approach used in conventional EP systems, including Hall thrusters, result in magnetic core elements (e.g., 122, 124, 126, 128) that although may operate well within their respective linear regimes, may approach saturation, or may transition into their respective nonlinear regimes, differently. In other words, such magnetic core elements (e.g., 122, 124, 126, 128) may transition from linear to nonlinear at different applied (high) magnetic fields and/or operate in the nonlinear regime according to different (saturation) response curves. Such imbalance (i.e., of magnetic flux) during operation through the respective nonlinear regimes of the magnetic core elements (e.g., 122, 124, 126, 128) may be considered inherent to the design approach and a primary cause of the above-described warping of the magnetic field lines (e.g., MFL_{NL} shown in FIG. 2B) in the discharge channel of conventional EP systems.

FIG. 3A shows a simplified cross-sectional schematic of a magnetic core (320) according to an embodiment of the present disclosure. The magnetic core (320) may be part of a magnetic circuit (320, 330) according to the present disclosure that includes the magnetic core (320) and a magnet system (330). Respective functionalities of the magnetic core (320), including magnetic core elements (322, 324, 326, 328), and magnetic circuit (330), may be taken from the above description with reference to items (120), including items (122, 124, 126, 128), and item (130) of FIG. 1B. It should be noted that for clarity purposes, elements/magnets (e.g., 330) of the magnet system (330) are shown distanced from elements (e.g., 324, 328) of the magnetic core (320). In general, the magnet system (330) can be considered as a conventional magnet system with description according to the above provided description with reference to item (130) of FIG. 1B.

The magnetic circuit (320, 330) according to the present disclosure may be used in any EP system, including the EP system (100) of FIG. 1A. As shown in FIG. 3A, symmetrically arranged (about the center axis, C_{L}, only one half of the cross sectional is shown) are elements/structures (322, 324, 326, 328) that form the magnetic core (320). The magnetic core (320) may be made of a magnetically permeable material (e.g., ferromagnetic material, soft magnetic material) that is magnetically energized via a magnet system (330, e.g., based on permanent magnets or electromagnets). Within the inner space (102c) of the discharge channel (102), the magnetic circuit (320, 330) may generate a radial magnetic field that is perpendicular to an electric field produced in (or about, e.g., via a combination of an anode and a cathode of the EP system) the discharge channel (102). It is noted that design/arrangement of the magnet system (330) for energization of the magnetic core (320) via an applied magnetic field generated by the magnet system (330) is known in the art and not the subject of the present application.

With continued reference to FIG. 3A, the magnetic core elements (322, 324, 326, 328) according to the present teachings are designed to transition from the linear regime to the nonlinear regime at the same applied magnetic field and to operate in the nonlinear regime according to a same (saturation) response curve. In other words, the magnetic core elements (322, 324, 326, 328) according to the present teachings transition from the linear regime to the nonlinear regime at the same applied magnetic field and saturate at the same rate. Accordingly, the magnetic flux density, and therefore the total magnetic flux, through the magnetically permeable material of the magnetic core elements (322, 324, 326, 328) according to the present disclosure is substantially the same (e.g., equal, balanced) throughout operation in the linear regime and the nonlinear regime, including through a transition from the linear regime to the nonlinear regime (and vice versa). In other words, for a given applied magnetic field, the magnetic flux density, and therefore the total magnetic flux, through the inner core (328), the inner screen (326p), the outer core (324), the outer screen (326d), and the baseplate (322), of the magnetic core (320) according to the present disclosure is substantially the same (e.g., equal, balanced) throughout operation in the linear regime and the nonlinear regime, including through a transition from the linear regime to the nonlinear regime (and vice versa).

It follows that the magnetic flux, including the magnetic flux density and the total magnetic flux, through the permeable material of the magnetic core elements (322, 324, 326, 328) according to the present teachings is said to be “balanced”. This means that for a change of the applied magnetic field, a resultant change in the magnetic flux induced in each element (322, 324, 326, 328) of the magnetic core (320) is proportional. In other words, a resultant increase/decrease in magnetic flux as measured as a percentage or a ratio is maintained across all elements of the magnetic core. In other words, the magnetic flux, including the magnetic flux density and the total magnetic flux, through the magnetic core elements according to the present disclosure is ratiometrically related. Teaching according to the present disclosure achieve such balancing of the magnetic flux density (and total magnetic flux) by designing each of the magnetic core elements (322, 324, 326, 328) to include a geometry (e.g., profile, shape, thickness) that provides a substantially same magnetic leakage, or in other words, a balanced magnetic leakage, across the magnetic core elements (322, 324, 326, 328).

Teachings according to the present disclosure can be said to provide a flux-balanced magnetic circuit configured to operate in a linear regime, a nonlinear regime, and/or a combination of linear and nonlinear regime. Operation of the flux-balanced magnetic circuit according to the present disclosure may include a contiguous range of operation (e.g., in terms of applied magnetic field and/or produced magnetic field) across the linear regime and the nonlinear regime. It is noted that flux-balancing according to the present disclosure may be equally considered as balancing of the magnetic leakage through the magnetic circuit. In some embodiment according to the present disclosure, the balancing of the magnetic leakage may include balancing of the magnetic leakage not only across the magnetic core elements, but also across modes of operation (i.e., linear and nonlinear regimes).

With continued reference to FIG. 3A, a mode of operation of the flux-balanced magnetic circuit (320, 330) according to the present disclosure based on operation in the linear and/or nonlinear regime may be based on a range of operation of, for example, a (radial) magnetic field strength applied (by the magnetic circuit 320, 330) within the discharge channel (102). For example, at lower magnetic field strengths (e.g., lower than about 200 G), the flux-balanced magnetic circuit (320, 330) may operate in the linear regime, and at higher magnetic field strengths (e.g., higher than about 200 G), the flux-balanced magnetic circuit (320, 330) may operate in the nonlinear regime.

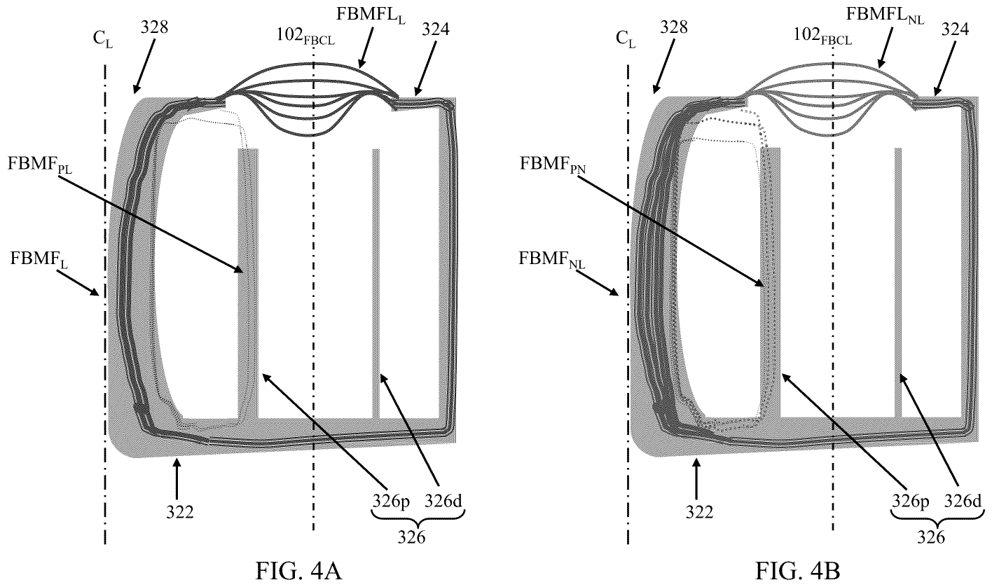

As previously noted in the present disclosure, and with new reference to FIG. 4A and FIG. 4B, while allowing tuning (e.g., via an applied magnetic field) of the (radial) magnetic field strength applied within the discharge channel (102) for operation in the linear regime (e.g., FIG. 4A) or nonlinear regime (e.g., FIG. 4B), flux-balancing according to the present disclosure (substantially) maintains a shape/profile of the magnetic field (lines) (e.g., FBMFL_{L} of FIG. 4A and FBMFL_{NL} of FIG. 4B) in (the air gap of) the discharge channel (102) for efficient operation of the EP system.

Teachings according to the present disclosure may not attempt to remove magnetic leakages in the magnetic circuit (320, 330), rather design each element (322, 324, 326, 328) of the magnetic core (320) in order to provide a flux-balanced magnetic circuit in spite of the magnetic leakages. Because magnetic leakage in each element (322, 324, 326, 328) of the magnetic core (320) may exhibit differently, based on, for example, shape and connection/vicinity to adjacent/other elements (e.g., 322, 324, 326, 328) of the magnetic core/circuit (320, 330), then, and as shown in FIG. 3A, each such element (e.g., 322, 324, 326, 328) may include a different magnetic leakage compensation profile, predominantly based on tuning of the thickness profile of each element. In some embodiments according to the present disclosure, flux-balancing may include tuning of the thickness profile in order to increase or decrease magnetic leakage in one or more elements (322, 324, 326, 328) of the magnetic core (320) so to balance the magnetic leakage across all of the elements (322, 324, 326, 328), and thereby balancing the magnetic flux.

According to an embodiment of the present disclosure, and with continued reference to FIG. 3A, tuning of the thickness profile (e.g., thickness along the magnetic flux lines) of the elements (322, 324, 326, 328) of the magnetic core (320) according to the present disclosure may be provided via finite element model (FEM) simulations of the magnetic field produced in (the air gap of) the discharge channel (102), or an air gap representing the discharge channel (102). Through an algorithm which rapidly simulates the produced magnetic fields (e.g., shape/profile/symmetry and strength) based on applied magnetic fields to the magnetic core (320), it is possible to (e.g., iteratively) adjust the thickness/profile of the material throughout the magnetic core (320), including throughout each element (322, 324, 326, 328) of the magnetic core (320), such that all elements reach the nonlinear regime at a same (e.g., substantially equal) applied magnetic field, and maintain a same magnetic leakage for a same (e.g., substantially equal) applied magnetic field throughout the nonlinear regime.

Left side of FIG. 3B contrasts thickness profiles of the conventional magnetic core (120, e.g., FIG. 1B) to the (flux-balanced) magnetic core (320, e.g., FIG. 3A)) according to the present disclosure. As shown in FIG. 3B, and with further reference to FIG. 1B and FIG. 3A, FEM simulations according to the present disclosure may result in varying/changing (e.g., provided via curvatures and/or slopes, including relative curvatures and/or slopes between opposite surfaces) thickness profiles that deviate from conventional (e.g., square) thickness profiles. As shown in the bottom left corner of FIG. 3B, a conventional thickness profile (120) may include flat and parallel cross-sectional profiles indicative of constant/fixed thicknesses and surfaces that are either along the axial direction (e.g., parallel to C_{L}) or traverse the axial direction (i.e., radial direction, orthogonal to C_{L}), or in other words, a square profile. On the other hand, as can be clearly seen in the top left corner of FIG. 3B, a thickness profile of the elements (322, 324, 326, 328) according to the present disclosure may include curved and/or sloped cross sectional profiles indicative of variable/changing thicknesses and surfaces (or segment of surfaces) that are not necessarily parallel or orthogonal to the axial direction, or in other words, a curved/sloped profile. In other words, whereas the elements (124, 126, 128) of the conventional magnetic core (120) may be straight cylinders including cylindrical inner/outer (e.g., inwardly/outwardly) surfaces separated by constant/fixed distances (i.e., thicknesses), the elements (324, 326, 328) of the present magnetic core (320) may include a combination of straight cylinders and cylindrical/tubular structures that include inner and/or outer surfaces with slopes or curvatures. Similarly, whereas the element (122) of the conventional magnetic core (120) may be a flat/planar plate including round flat/planar inner/outer (e.g., downstream/upstream) surfaces separated by constant/fixed distances (i.e., thicknesses), the element (322) of the present magnetic core (320) may be a plate having at least one surface that includes a slope and/or a curvature.

As shown in the exemplary case of FIG. 3A, the axial extension (e.g., 328c) of the inner core (328) may include a curved thickness profile provided by an inner surface (e.g., looking at the discharge channel 102) that is (e.g., inwardly) curved and an outer surface (e.g., looking away the discharge channel 102) that is (e.g., inwardly) curved. On the other hand, the top radial extension (e.g., 328p) of the inner core (328) may include a sloped thickness profile provided by at least one sloped surface (e.g., surface looking upstream).

According to an embodiment of the present disclosure, the slopes and/or curvatures according to the present thickness profiles are based on the shape of the magnetic flux lines conducted through the permeable material of the respective elements (e.g., 322, 324, 326, 328) of the magnetic core (320). Such slopes and/or curvature may allow for conduction of higher magnetic flux densities while following the contours of the magnetic flux lines. Accordingly, a thickness profile according to the present disclosure can be said to vary along with the magnetic flux lines. This can be seen, for example, in FIG. 4A/4B wherein the thickness profile of the inner pole (328) is shown to substantially follow the magnetic flux lines, FBMF_{L} for the linear regime, and FBMF_{NL} for the nonlinear regime. The thickness profile according to the present disclosure can be said to provide elements (e.g., 322, 324, 326, 328) with respective thickness profiles that include regions/segments where thickness increases or decreases along any one of an axial extension or radial extension of the elements. Such thickness increase or decrease may be along the axial extension of an element (e.g., 322, 324, 326, 328) in a downstream direction or in an upstream direction, and/or along the radial extension of the element in an inwardly direction (towards axis C_{L}) or outwardly direction (away from axis C_{L}). Such thickness increase or decrease may be provided via curved and/or sloped segments of at least one respective surface of the elements (e.g., 322, 324, 326, 328).

In other words, FEM simulations according to the present disclosure may take into consideration magnetic flux densities present in the elements (322, 324, 326, 328) of the magnetic core (320) and correspondingly adjust air/vacuum gaps in order to control (e.g., reduce or increase with the goal to equalize) magnetic flux and leakages. In the exemplary case of the magnetic core (320), because of the (substantially) reduced (average) diameter of the (substantially) cylindrical inner pole (328) compared to the (average) diameter of the (substantially) cylindrical inner outer core (324), a substantially higher density magnetic flux may be present in the inner core (328) compared to the outer core (324). Accordingly, the FEM simulations according to the present disclosure may determine that by increasing the air/vacuum gap between the inner core (328) and the inner screen (326p), at the cost of decreasing the air/vacuum gap between the outer core (324) and the outer screen (326d), a lower magnetic leakage can be obtained through the (magnetically denser) inner core (328). For example, by iteratively increasing the air/vacuum gap between the inner core (328) and the inner screen (326p) and therefore decreasing the air/vacuum gap between the outer core (324) and the outer screen (326d), leakage through the air/vacuum gap (328, 326p) may be iteratively reduced such to equalize with the leakage (that may or may not iteratively increase) through the air/vacuum gap (324, 326d).

Some effects of reducing magnetic leakages in order to control/equalize magnetic flux can be taken by contrasting, for example, FIG. 4A with FIG. 2A and FIG. 4B with FIG. 2B which show that, by (for example) increasing the air/vacuum gap between the inner core (328) and the inner screen (326p) when compared to the air/vacuum gap between the inner core (128) and the inner screen (126p), (substantially) reduced magnetic leakages FBMF_{PL} and FBMF_{PL} during operation in the linear and nonlinear regime of the magnetic core (320) can be obtained when compared to the magnetic leakages MF_{PL} and MF_{PL} during operation in the linear and nonlinear regime of the magnetic core (120). Furthermore, because such reduction in magnetic leakage is in view to equalizing the magnetic flux trough the elements (322, 324, 326, 328), then as shown in FIG. 4A and FIG. 4B, a substantially same shape/profile of the (produced) magnetic field in (the air/vacuum gap of) the discharge chamber (102) can be observed during operation in the linear regime (magnetic field FBMFL_{L}) and in the nonlinear regime (magnetic field FBMFL_{NL}).

With further reference to FIG. 3A, tuning of the thickness profile of the elements (322, 324, 326, 328) of the magnetic core (320) according to the present disclosure allows for removal of an excess magnetically permeable material of the magnetic core (320) for a substantial decrease in the mass (and size) of the (Hall) thruster when compared to a conventional (Hall) thruster. Inventor of the present application has estimated a reduction in mass of the magnetic core in the range from 50% up to 60% while providing comparable (essentially same) magnetic field shape/profile (including symmetry) and strength in the air gap of the discharge channel. Furthermore, for a given target thruster mass, the flux-balanced magnetic circuit/core (320, 330) according to the present disclosure allows the thruster to (substantially) exceed the usual magnetic field strength limitations historically defined by the magnetic saturation behavior of conventional magnetic circuits.

FIG. 3B contrasts the size (and therefore mass) of the magnetic core (320) of FIG. 3A with the conventional magnetic core (120) of FIG. 1B. As can be clearly taken from FIG. 3B, the magnetic core (320) according to the present disclosure is shown in the top left corner of FIG. 3B and the conventional magnetic core (120) is shown in the bottom left corner of FIG. 3B. On the right side of FIG. 3B, the two magnetic cores (320, 120) are shown superimposed and aligned (horizontally) to the center axis, C_{L}, and vertically to the top (e.g., downstream direction/side) of the baseplates (322, 122). In order to highlight difference in size/mass between the two magnetic cores (320, 120), the conventional magnetic core (120) is rendered in a hashed pattern. Accordingly, the exposed hashed pattern shown in FIG. 3B can be considered as substantially representing the aforementioned excess magnetically permeable material of the magnetic core (120) removed from the magnetic core (320) of the present teachings.

With continued reference to FIG. 3B, it should be noted that both magnetic cores (320, 120) are designed to include a same size discharge channel (e.g., 102, not shown in FIG. 3B), and therefore a same discharge channel inner space (e.g., 102c, not shown in FIG. 3B), and a same separation/distance between the inner and outer poles (328/128, 324/124, not shown in FIG. 3B).

It should be noted that a priori assessing/predicting of conduction of magnetic flux through a magnetically permeable material of a magnetic circuit/core and resultant magnetic leakages may be considered as a highly complex problem to solve, due in part to its multidimensional nature (e.g., geometries, thicknesses, relative gaps/distances, permeability, magnetic field strength, etc., input parameters). This is a main motivation to present inventor for usage of FEM simulations that include iterative adjustments to the magnetic circuit/core with the goal of maintaining integrity of the produced magnetic field (lines) while balancing/equalizing the magnetic flux (and magnetic leakages) conducted through the elements of the magnetic circuit/core. Accordingly, any slight modification to a desired input parameter to the FEM simulation, may result in a substantially different (optimized) converging solution (e.g., thickness profile, geometry). In other words, there cannot be one exact thickness profile representative of the flux-balanced magnetic circuit/core according to the present teachings. In other words, the thickness profiles shown in FIG. 3A may be considered as exemplary in nature while being representative of features considered novel by the present inventor, including, thickness gradients/changes, curvatures, slopes, offsets of structures/surfaces, etc. It is noted that complexity in realizing/fabricating/manufacturing such features can be greatly reduced via known in the art subtractive and/or additive manufacturing methods and practices. As previously noted in the present disclosure, such manufacturing methods may allow realization of monolithic structures that monolithically integrate a plurality of the elements (e.g., 322, 324, 326, 328) of the flux-balanced magnetic circuit/core according to the present teachings.

Accordingly, a flux-balanced magnetic circuit/core (320, 330) for operation across a linear and a nonlinear region is described. The higher magnetic fields strengths as enabled by the flux-balanced magnetic circuit/core (320, 330) according to the present disclosure can be used for further reducing thruster mass/size while trading mass/size for applied magnetic field (e.g., coil current of an electromagnet). Because of the expanded operating headroom within the linear region provided by balancing of the magnetic flux (and magnetic leakages) and ability to operate (transition) into the nonlinear regime, the flux-balanced magnetic circuit/core (320, 330) according to the present disclosure can enables high power density operation, which typically requires higher magnetic fields.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A flux-balanced magnetic circuit for an electric propulsion (EP) system, comprising:
a magnetic core with a thickness profile that is configured to equalize a magnetic flux conducted through a magnetically permeable material of magnetic elements of the magnetic core during operation of the flux-balanced magnetic circuit in a linear regime and a nonlinear regime.

2. The flux-balanced magnetic circuit of claim 1, wherein
the magnetic elements include an inner core and an outer core separated at a downstream region of the magnetic core by a gap, and
equalization of the magnetic flux provides an equal magnetic flux conducted through the inner core and the outer core resulting in a substantially constant shape of magnetic field lines produced in the gap during operation in the linear regime and nonlinear regime.

3. The flux-balanced magnetic circuit of claim 1, wherein
the thickness profile is further configured to equalize leakage of the magnetic flux through the magnetically permeable material of the magnetic elements of the magnetic core during operation of the flux-balanced magnetic circuit in the linear regime and the nonlinear regime.

4. The flux-balanced magnetic circuit of claim 3, wherein
the magnetic elements include an inner core and an outer core separated at a downstream region of the magnetic core by a gap, and
equalization of the leakage of the magnetic flux provides an equal magnetic flux leakage through the inner core and the outer core resulting in a substantially constant shape of magnetic field lines produced in the gap during operation in the linear regime and nonlinear regime.

5. The flux-balanced magnetic circuit of claim 3, wherein
the magnetic elements include an inner core and an outer core separated at a downstream region of the magnetic core by a gap, and
equalization of the leakage of the magnetic flux provides an equal magnetic flux conducted through the inner core and the outer core resulting in a substantially constant shape of magnetic field lines produced in the gap during operation in the linear regime and nonlinear regime.

6. The flux-balanced magnetic circuit of claim 1, further comprising a magnetic system configured to magnetically energize the magnetic core via an applied magnetic field, the magnetic system comprising a permanent magnet or an electromagnet.

7. The flux-balanced magnetic circuit of claim 6, wherein
the linear regime is in correspondence of a lower strength of the applied magnetic field wherein the magnetically permeable material of the magnetic elements operates away from a corresponding magnetic saturation region, and
the nonlinear regime is in correspondence of a higher strength of the applied magnetic field wherein the magnetically permeable material of the magnetic elements operates within the corresponding magnetic saturation region.

8. The flux-balanced magnetic circuit of claim 1, wherein the thickness profile includes a region with a varying thickness.

9. The flux-balanced magnetic circuit of claim 8, wherein the region with the varying thickness is along an axial direction of the magnetic core.

10. The flux-balanced magnetic circuit of claim 8, wherein the region with the varying thickness is along a radial direction of the magnetic core.

11. The flux-balanced magnetic circuit of claim 8, wherein the thickness profile includes a curvature and/or a slope in the region with the varying thickness.

12. The flux-balanced magnetic circuit of claim 8, wherein the varying thickness is configured to follow a contour of magnetic flux lines of the magnetic flux in said region.

13. The flux-balanced magnetic circuit of claim 8, wherein the varying thickness is configured to increase a material thickness in said region of the magnetic core where the magnetic flux has a higher density.

14. The flux-balanced magnetic circuit of claim 8, wherein the varying thickness is configured to decrease a material thickness in said region of the magnetic core where the magnetic flux has a lower density.

15. The flux-balanced magnetic circuit of claim 8, wherein the varying thickness is configured to increase length of gaps between the magnetic elements so to reduce leakage of the magnetic flux through the gaps.

16. The flux-balanced magnetic circuit of claim 8, wherein the thickness profile associated to at least one magnetic element of the magnetic elements of the magnetic core includes the region with the varying thickness.

17. The flux-balanced magnetic circuit of claim 16, wherein the at least one magnetic element includes an inner core of the magnetic core.

18. The flux-balanced magnetic circuit of claim 17, wherein
an axial extension of the thickness profile associated with the inner core includes the region with the varying thickness, and/or
a downstream radial extension of the thickness profile associated with the inner core includes the region with the varying thickness.

19. The flux-balanced magnetic circuit of claim 18, wherein
the region with the varying thickness includes a thickness reduction and/or thickness increase in a downstream direction of the axial extension.

20. The flux-balanced magnetic circuit of claim 18, wherein
the region with the varying thickness includes a thickness reduction in an outer radial direction of the downstream radial extension.

21. The flux-balanced magnetic circuit of claim 18, wherein
the region with the varying thickness includes a thickness increase in an outer radial direction of the downstream radial extension.

22. The flux-balanced magnetic circuit of claim 17, wherein
the varying thickness is provided by way of a first curvature and a second curvature at said region, and
an axial extension of the thickness profile associated with the inner core is provided by the first curvature and the second curvature arranged on opposite surfaces of the axial extension at said region.

23. The flux-balanced magnetic circuit of claim 16, wherein the at least one magnetic element includes a baseplate of the magnetic core.

24. The flux-balanced magnetic circuit of claim 23, wherein
a radial extension of the thickness profile associated with the baseplate includes the region with the varying thickness, the varying thickness configured to provide a higher thickness at a region proximal an inner core of the magnetic core and a lower thickness at a region proximal an outer core of the magnetic core.

25. A reduced mass high-power Hall thruster, comprising:
a discharge chamber with a longitudinal extension according to an axial direction of the Hall thruster; and
a magnetic circuit for generation in the discharge chamber of magnetic field lines according to a radial direction, the magnetic circuit comprising a magnetic core and a magnet system;
wherein
the magnetic core includes a thickness profile that is configured to equalize a magnetic flux conducted through a magnetically permeable material of the magnetic core during operation of the magnetic circuit in a linear regime and a nonlinear regime, thereby maintaining a substantially constant shape of the magnetic field lines during operation in the linear regime and the nonlinear regime, and
the thickness profile includes a region with varying thickness, wherein the thickness profile in the region with the varying thickness is configured to follow a contour of magnetic flux lines of the magnetic flux, thereby reducing mass of the magnetic core by removing portions of the magnetically permeable material devoid of magnetic flux.

26. A method for reducing mass and size of a magnetic circuit of an electric propulsion (EP) system, the method comprising:
providing dimensions of a discharge channel of the EP system;
providing desired shape of a magnetic field produced in the discharge channel by a magnetic circuit of the EP system;
based on the providing and the providing, iteratively tuning a thickness profile of a magnetic core of the magnetic circuit while validating provision of the desired shape of the magnetic field via finite element model (FEM) simulation of a correspondingly produced magnetic field;
repeating the iteratively tuning of the thickness profile for different strengths of the produced magnetic field, the different strengths spanning across a linear regime and a nonlinear regime of the magnetic circuit; and
based on the repeating, deriving an optimal thickness profile of a flux-balanced magnetic core that is configured to equalize a magnetic flux conducted through a magnetically permeable material of the magnetic core during operation of the magnetic circuit in a linear regime and a nonlinear regime.

27. The method according to claim 26, wherein the iteratively tuning of the thickness profile includes:
tuning of the thickness profile via inclusion of a region with varying thickness, wherein the thickness profile in the region with the varying thickness is configured to follow a contour of magnetic flux lines of the magnetic flux, thereby reducing mass and size of the magnetic core by removing portions of the magnetically permeable material devoid of magnetic flux.
